(19) United States
(12) Patent Application Publication
(10) Pub. No.: US 2003/0021647 A1
(43) Pub. Date: Jan. 30, 2003

(54) Machine or plant with a duct and method for assembling a duct

(76) Inventors: Werner Groitl, Stetten (DE); Anton Kienle, Salgen (DE)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/198,093

(22) Filed: Jul. 19, 2002

(30) Foreign Application Priority Data
Jul. 27, 2001 (DE) 101 36 558.6

(51) Int. Cl. B23C 9/00; B23Q 11/02

(52) U.S. Cl. 409/137

(57) ABSTRACT

The invention relates to a machine or plant with at least one duct or duct profile for draining liquid media, in particular coolants or flushing liquids. The machine or plant is incorporated in a machine tool table. A seal is arranged between the machine tool table and the duct profile. The invention also relates to a method for assembling the duct with a seal.

### FIELD OF THE INVENTION

The invention relates to a machine or plant with at least one duct or duct profile for draining liquid media, in particular coolants or flushing liquids, which is incorporated in a machine tool table and wherein a seal is arranged between the machine tool table and the duct profile.

### BACKGROUND OF THE INVENTION

In modern transfer lines, machining centres, machines or plant there is a duct beneath the machining region in which the coolant or flushing agent is carried away. Coolants or flushing agents contain abraded shavings etc. which also have to be washed away by the coolant or flushing agent. The coolant and flushing agents are generally also very aggressive so escape from the machine or plant has to be prevented.

Machining halls are known, in particular in the automotive sector, which are kept meticulously clean. Of course it is also required that the machining centres are appropriately fluid tight so no fluid can escape therefrom.

The construction is generally such that a duct profile protected from the machine tool table by appropriate splash boards or guiding plates is incorporated in the machine tool table. It should be taken into account that the coolant or flushing agent not only drips into the duct but sometimes is also sprayed into the duct with some momentum and there is then accordingly the risk of the coolant or flushing agent spraying up or escaping at the side of the machine tool table. The same problem also exists when joining a plurality of machine or plant parts of the previously described type at the connecting points between these machine or plant parts and at the correcting points of the duct profiles to be mounted thereon.

Seals between the duct profile and the machine or plant are already known from the prior art for this purpose.

In a first known design a U-profile, in which an inflatable hose is inserted, is arranged on the upper edge of a sheet metal channel forming the duct. This hose then covers the gap between the channel and the machine frame. The disadvantage of this design is that the hose can become damaged. However, it can also become leaky and the pressure required to inflate the hose has to be regularly controlled. Excessive pressure in the hose can also damage the sheet metal construction of the channel or duct. Owing to the excessive pressure inside the hose it is possible for the sheet metal parts of the sheet metal construction to bend. It should also be noted in this case that there are sharp edges in sheet metal constructions so there is a certain further risk of damage to the hose.

In another known solution of the prior art a sealing profile is placed on the upper strip-like edge, which profile is intended to cover the gap between machine bed and channel. The seal hitherto had to be assembled if the channel was incorporated below the machine bed. The drawback of this solution is that this region is extremely difficult to reach. The operations to assemble the seal are also very complicated and difficult to check as after assembly the region cannot be checked by sight. Therefore a check as to whether the seal is securely mounted or correctly positioned is not possible.

A seal is therefore also necessary as not only can sprayed-up coolant or flushing agent escape at the gaps but it is also possible for coolant vapour to escape through small gaps between duct and machine frame which then condense in the colder region of the machine frame and drip. This also has the same effect as a leakage. Solutions are also known from the prior art where no seal is provided between machine frame or plant part and the duct element. In this case there is merely a seal owing to the overlap of connecting parts between duct element and machine part.

All solutions known from the prior art have the drawback that there is no guarantee of absolute imperviousness to the escape of coolant or flushing agent. In addition, the assembly of the duct elements for the coolant or flushing agent ducts is very complicated and, in particular in seals to be installed, a check cannot subsequently be made as to whether the seal was actually produced as required.

Proceeding from the above-described prior art the object of the invention is to provide a machine or plant with a duct which provides reliable protection against the escape of coolant or flushing agent from the connecting points between machine frame and coolant or flushing agent duct and simultaneously facilitates assembly of the duct parts or elements.

### SUMMARY OF THE INVENTION

According to the invention this object is proposed by the features in the independent claims 1, 2, 24 for the machine or plant and in the independent claims 33 and 37 for an assembly method.

An above-described machine or plant with at least one duct or duct profile for draining liquid media, in particular coolants or flushing agents, the duct or duct profile being incorporated in a machine tool table, and a seal being arranged between the machine tool table and the duct profile, which is characterised in that in that machine tool table has at least one leg reaching into the duct profile, the leg comprising a sealing area cooperating with the seal or carrying the seal and the leg being designed in such a way that it acts as a splash guard for the seal, is proposed by the invention. Owing to the particular design of the leg reaching into the duct profile but simultaneously carrying the sealing area or the seal itself and acting as a splash guard for the seal, a sufficiently fluid tight connection between machine frame and duct profile is consequently possible. An additional splash guard is therefore also possible for the seal owing to the type of formation of the sealing face on the machine tool table. The coolant or flushing agent is no longer sprayed directly onto the seal or sealing face, rather, if at all, merely indirectly, i.e. in a diminished fashion.

A machine or plant with at least one duct or duct profile for draining liquid media, in particular coolants or flushing agents, incorporated in a machine tool table, and a seal being arranged between the machine tool table and the duct profile, is proposed in the independent claim 2 which is characterised in that the seal is arranged at or on the longitudinally extending end of the duct profile. The seal can therefore cooperate with the sealing area of the machine tool table wherein it is insignificant to this solution where the sealing area is formed in the leg of the machine tool table. This type of arrangement of the seal allows sealing with a horizontal perpendicular and obliquely arranged sealing area. It is also possible to seal the duct element at the top, at the bottom or to the side, based on the installation position. However, according to the invention it is also possible to arrange the sealing area or a seal-carrying sealing area at or on the longitudinally extending end of the duct profile.

The interaction between the solution proposed in claim 1 with the solution proposed in claim 2 provides a particularly advantageous type of seal between machine tool table and duct profile. However, both solutions can also be achieved independently of one another.

According to a development of the solution according to the invention it is provided that the sealing areas of the machine tool table are arranged in an outwardly pointing U-shaped or nose-like opening of the leg.

According to a further aspect of the solution according to the invention it is possible for the duct profile to be formed with a U-shaped or nose-like upper edge for example flanged sheet metal edge open at the bottom, on the open side of which a seal is arranged. Formation of the sealing area or a seal-carrying sealing face is also provided here on the upper edge of the duct profile in accordance with the principle of kinematic reversal.

The above-described solutions illustrate embodiments of the solutions according to the invention mentioned in claims 1 and 2. However, in view of the solutions protected in claims 1 and 2 a plurality of the most varied of solutions or solution variations can be conceived of in this regard. Advantageous designs are mentioned by the solutions protected in claims 3 and 4 which ensure a very reliable and tight production of the seal between machine frame and duct profile.

A development of the solution according to the invention provides that the duct profile is provided with a U-shaped upper edge open at the top in the installation direction. This solution for forming the duct profile is chosen, for example, if the seal of the duct profile is to be provided toward the top in the installation direction; the seal is then already reliably guided and mounted.

A development of the solution according to the invention is characterised in that the seal is designed in such a way that it can be placed with one side on the upper edge of the duct profile, so it encloses and simultaneously seals, in particular with interlocking and/or non-positive fit, the open side of the duct profile. With this type of design of the seal it is ensured that, on the one hand, assembly of the seal is facilitated in such a way that it is merely placed on the upper edge of the duct profile. However, at the same time it is thereby ensured that both the tightness of the duct profile with the seal is produced and that the seal cannot slip during assembly of the duct profile.

A further aspect of the solution according to the invention provides that the other side of the seal pointing toward the sealing face of the machine tool table forms the seal between machine tool table and duct profile.

The invention also proposes that the sealing face of the machine tool table is designed in such a way that the seal can be placed with one side on the sealing face of the machine tool table or can be inserted into the face (for example into a groove) and the side of the seal pointing toward the duct profile then cooperates with a sealing area arranged on the upper edge of the duct profile and thus closes and seals the gap between duct profile and machine tool table. The invention incorporates the kinematic reversal of the proposed concepts and means in every aspect (even in the assembly method).

It has also been found that it is advantageous if the seal is formed on the side pointing toward the sealing area of the machine tool table as a rounded profile or as a square profile.

In a development of the solution according to the invention it is provided that, at the side pointing toward the sealing area of the machine tool table, the seal additionally has at least one sealing nose directed toward the sealing area or at least one sealing lip. This ensures a further increase in the reliability of the seal as a whole.

According to a development of the solution according to the invention it is possible for the seal to be designed as a lip seal at the side pointing toward the sealing area of the machine tool table.

It is irrelevant for the formation of the surfaces of the sealing areas of the machine tool table whether these are crude, cast or machined. It is ensured owing to the type of design of the seal according to the invention that no coolant or flushing agent can escape at the connecting point between machine tool table and duct element. The duct profiles can be formed from metal, sheet metal, plastics material or from composite materials.

In an advantageous development of the solution according to the invention it has been found that it is advantageous if the duct profile has at least one assembly aid by means of which the duct profile can be raised or lowered.

It is particularly advantageous in this case if the assembly aid is arranged below the duct profile. A development of the above-mentioned solutions provides that the assembly aid is formed by at least one eccentric. Therefore the duct profile can either be raised or lowered using the assembly aid in accordance with the design of the profiles or sealing areas of the machine tool table. The duct profile can be held in the adjusted position by this assembly aid as the duct profile is inserted into the machine tool table, so there is no undesired contact between the duct element and the machine tool table until the duct element reaches its assembly position under the machine toot table and is then either lowered or raised.

It is advantageous if the assembly aid is formed so as to be mountable and detachable. This assembly aid will therefore only have to be provided in relatively small piece numbers for the respective assembly so a certain material-economic effect is achieved.

However, the assembly aid can also be formed by rails and/or rollers which can be arranged beneath the duct profile.

In a development of the invention it is provided that at least one connecting part with a leg reaching into the duct profile and comprising a sealing area cooperating with the seal or carrying the seal, the leg being designed in such a way that it acts as a splash guard for the seal, is arranged between connecting side of the machine tool table and extensions of the machine tool table which are to be fitted onto the connecting side. The connecting part is understood in this case to be a component of the duct profile. It is hereby achieved that the same sealing possibility is also produced at the connecting point between the machine tool table and an extension of the machine tool table or the plant as has already been proposed between the duct element and the machine tool table.

A development of this solution provides that the leg pointing into the duct profile is designed as a moulding bent so as to be U-shaped or nose-like.

It has also been found that it is advantageous if the upper end of the connecting part is adapted to the shape of the machine frame and if the connecting part is designed so as to be fastenable to the machine frame.

One aspect of the solution according to the invention provides that a sealing plate which is trapezoidal in cross-section is arranged between the slope of the upper nose of the duct or duct profile and the connecting part described above. Additional security is provided with respect to escaping coolant or flushing agent owing to this sealing plate.

According to the invention a solution is also provided which is intended for a machine or plant with at least one duct or duct profile, wherein in the installed state below the machine tool table the duct profile is arranged in the ground or in the assembly surface of the machine tool table. This solution is characterised in that at least one covering strip corresponding to the shape of the cross-section of the machine tool table at the connecting face or the shape of the connection at the duct profile is arranged between duct or duct profile and machine tool table as part of the duct profile.

A development of this solution provides that the covering strip carries sealing profiles both on the side pointing toward the connecting face of the machine tool table and on the side pointing toward the duct profile. The sealing profile on the side pointing toward the covering strip is designed in such a way that it can be placed thereon so it encloses and simultaneously seals the upper edge with interlocking and/or non-positive fit. The sealing profile on the side pointing toward the duct or the duct profile on the covering strip is advantageously bent outwards, viewed from the duct profile.

To fasten the bent sealing profile to the covering strip it is proposed that the sealing profile is arranged with a side of the corner non-positively and/or with interlocking fit in a recess of the covering strip.

A development of the above-described solution according to the invention provides that, at the side pointing toward the duct or duct profile, the covering strip is bent toward the duct interior and, more precisely, in such a way that it extends obliquely from the end of the recess and then vertically again into the duct interior. A splash guard for the seal of the covering strip is simultaneously provided on the duct or duct profile owing to this discovered possibility for designing the covering strip.

Machines or plant of the above-described type are frequently erected in such a way that they are at a gradient to the assembly surface. However, it can also be possible for the duct profile to be incorporated with a gradient. The dimensions of the opening between duct profile and machine tool table therefore change and therefore the required dimensions of the covering strip also. A development of the solution according to the invention therefore provides that the covering strip is adapted in its dimensions to the gradient of the machine tool table or the duct or duct profile.

It has been found that it is advantageous if the seal and the sealing profile are formed as microcellular rubber, silicone, unvulcanised rubber, vulcanised rubber or made from a heat and chemical-resistant vulcanisable fluoroelastomer based on vinylidene fluoride hexafluoropropylene copolymerisates (such as Viton), in particular from a material resistant to the medium or media to be sealed. Viton is a trademark-protected indicator of the above-described sealing materials and is resistant, in particular, to very aggressive media.

According to the invention a method for assembling machines or plant, under the machine tool table of which at least one duct profile is incorporated, is proposed. The duct profile carrying the seals at its open end is inserted into the machine tool table in such a way that the sealing face arranged on the duct profile and cooperating with the seals is spaced apart from the sealing area of the machine tool table cooperating with the seal in such a way that a gap remains between seal and sealing area. Once the duct profile has achieved its assembly position, there is a relative movement of duct profile with respect to machine tool table in order to close the gap.

Depending on the design and arrangement of the sealing faces and seals on the machine tool table or on the duct profile the relative movement is possible either in the horizontal or in the vertical direction of movement. The direction of movement is therefore defined by the design or arrangement of the seals and sealing faces.

According to a development of the above-described method it is provided that the duct profile is inserted in openings of the machine tool table at a higher or lower level with respect to the sealing area, depending on the design of the upper edge of the duct profile, in such a way that the sealing profiles still do not come into contact with the sealing areas of the machine tool table. After reaching the end position with respect to the machine tool table the duct profile is lowered or raised and, more precisely in such a way that the sealing profiles come into contact with the sealing areas of the machine tool table or of the duct profile and produce the seal.

In a development of the method according to the invention it is proposed that in a first method step the duct profile is inserted in the openings of the machine tool table with a spacing in relation to the sealing face, depending on the design of this sealing area and, more precisely, in such a way that the sealing profiles cannot come into contact with the sealing faces of the machine tool table or of the duct profile. In a next method step, after achieving the end position with respect to the machine profile, the duct profile, in particular with its open end, is moved vertically in such a way that the sealing profiles come into contact with the sealing areas of the machine tool table or of the duct profile and produce the seat. The duct profile can also move obliquely with its open side if the arrangement of the sealing areas requires this.

A development of the method according to the invention is characterised by the use of an assembly aid by means of which the duct profile is raised and lowered and during insertion of the duct profile the latter is held in the raised or lowered position until it has achieved the end position. The assembly aid also serves to facilitate insertion of the duct profile in that, for example, rails and rollers are arranged below the duct profile so the latter can be pushed very easily under the machine tool table.

The object posed according the invention is also achieved by a method for assembling machines or plant, under the machine tool table of which at least one duct profile is incorporated, which is characterised by the following sequence of method steps:

the gap between duct profile and machine frame is covered by means of at least one covering strip,

the covering strip(s) is/are fastened by fastening means, provided on the machine frame, arranged thereon and corresponding therewith.

### BRIEF DESCRIPTION OF THE DRAWINGS

The various other uses of the present invention will become more apparent by referring to the following detailed descriptions and drawings in which:

FIG. 1a, b is a section through the lower side of a machine tool table with duct profile arranged thereon in the installed state (FIG. 1a) and in the assembly position (FIG. 1b) and

FIG. 2 is a section through the lower side of the machine tool table with duct profile arranged thereon, below the assembly surface.

### DETAILED DESCRIPTION OF THE PREFERRED EMBODIMENTS

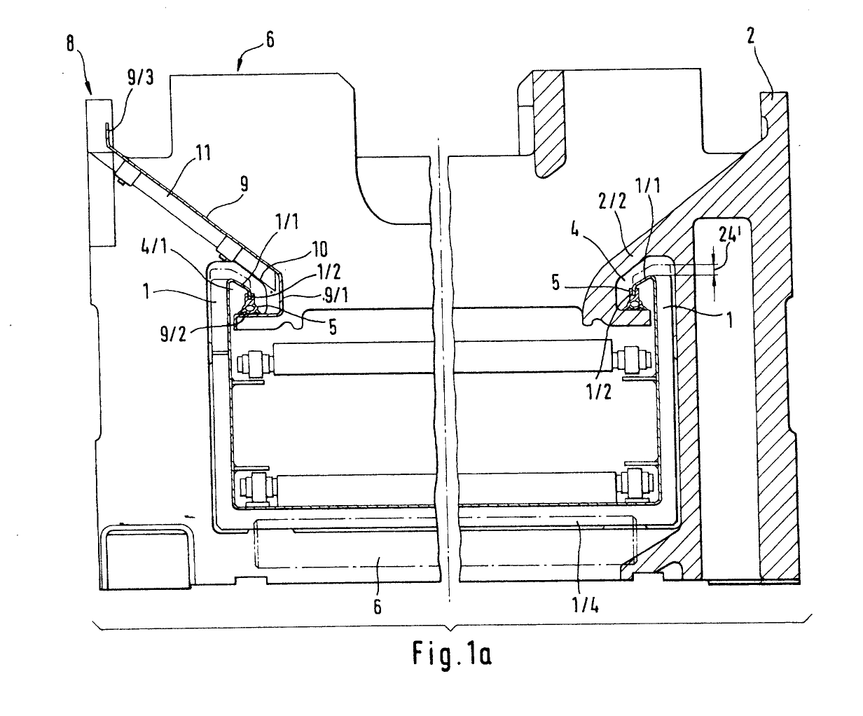

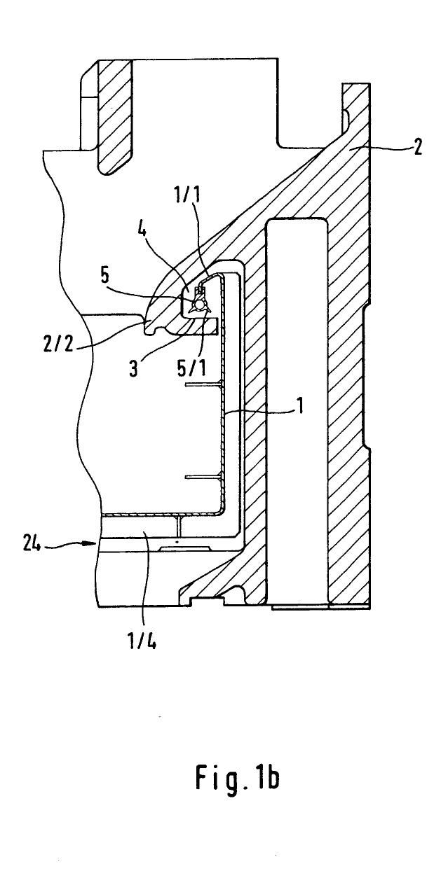

FIG. 1a, b shows a section through the lower side of a machine tool table 2 with duct profile 1 arranged thereon above the assembly surface of the plant or machine. The machine tool table 2 has in this case a leg 2/2 reaching into the duct profile 1, the sealing area 3 of the machine tool table 2 being arranged in an outwardly pointing U-shaped or nose-like opening 4 of the leg 2/2 in the diagram of FIG. 1a. The duct profile 1 is designed in the diagram of FIG. 1a with a U-shaped or nose-like upper edge 1/1 which is open at the bottom and the open side 1/2 of which carries a seal 5. In the diagram of FIG. 1a the duct profile 1 is already in a lowered state. In the detail shown in FIG. 1b the duct profile is in a raised state.

It can be seen more clearly in this diagram (FIG. 1b) that the sealing profile 5 additionally carries a sealing nose 5/1 directed toward the sealing area 3 which can also be designed as a sealing lip. An assembly aid 6 is arranged below 1/4 of the duct profile 1.

The assembly aid can be formed by rollers and rails on the lower side of the duct profile or by one or more eccentrics. The duct profile 1, for example, is either raised or lowered by the assembly aid 6 or else inserted in the machine tool table during assembly.

The diagram of FIG. 1a shows a solution for connection between connecting side 7 of the machine tool table 2 and extensions 8 or the machine tool table 2. Here a connecting part 9 is provided as part of the duct profile 1 with a leg 9/1 reaching into the duct profile 1 and comprising a sealing area 9/2 cooperating with the seal or carrying the seal 5, the leg 9/1 being designed in such a way that it simultaneously acts as a splash guard for the seal 5.

In the diagram of FIG. 1a, b the leg 9/1 pointing into the duct profile 1 is designed as a U-shaped or nose-like or hook-like bent moulding. It roughly corresponds to the design of the leg 2/2. The upper end 9/3 of the connecting part 9 is adapted to the shape of the machine frame 2 at the fastening point.

A sealing plate 11 designed so as to be trapezoidal in cross-section is arranged between the oblique 10 of the upper nose of the duct or of the duct profile 1 and the connecting part 9.

The solution principle shown in FIG. 1a, b is particularly suitable for raising the duct profile 1 to a level 24, 24′ by means of the assembly aid 6 so the pre-assembled seals 5 are no longer connected to the sealing area 3 or 9/2 or are distanced therefrom. This position is shown on the right-hand detail side of FIG. 1a. In this position the duct profile 1 is inserted or run into the machine tool table. After achieving its end position the duct profile 1 is lowered with the help of the assembly aid 6. This solution is particularly advantageous as a sufficiently reliable seal is achieved owing to the inherent weight of the duct profile 1. The seal is also extremely well protected by the nose-like design of the leg and the arrangement of the sealing areas universally provided thereon.

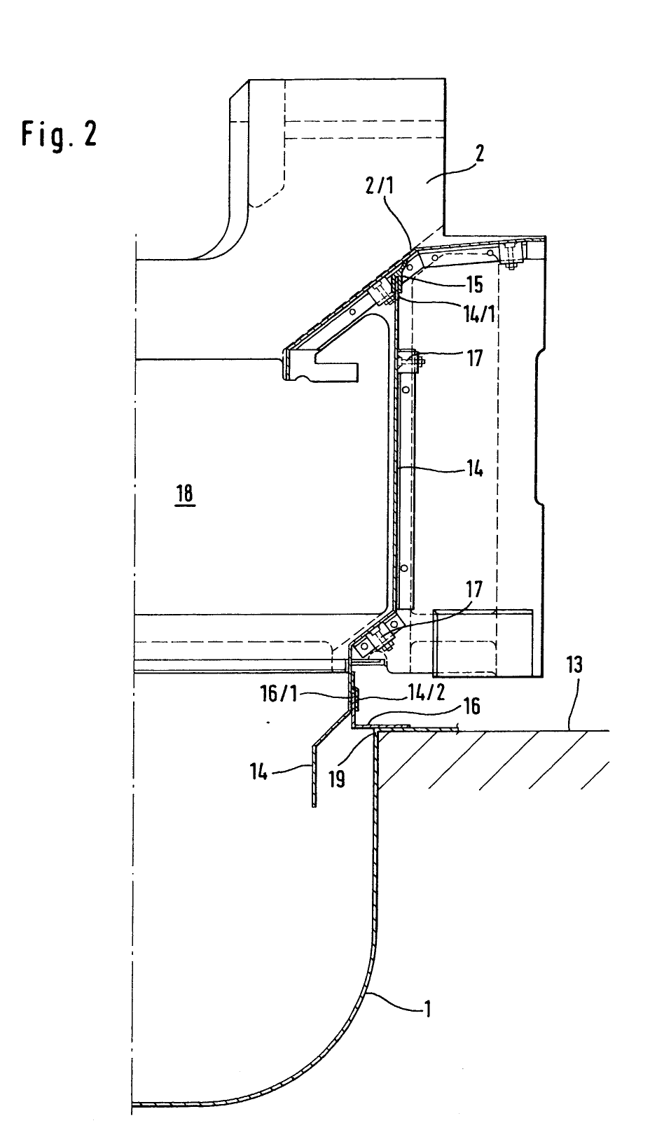

FIG. 2 shows a section through the lower side of a machine tool table with duct profile 1 arranged thereon, below the assembly surface 13 of the machine or plant. In this embodiment there is a gap 18 between machine tool table 2 and duct profile 1 as the duct profile has been let into or set in concrete in the floor or the assembly surface 13. A covering strip 14 is arranged between the connecting face 2/1 on the machine tool table 2 and the connecting face 19 on the duct profile 1 to close this gap. This covering strip 14 carries both at the side facing the connecting face 2/1 of the machine table 2 and at the side facing the duct profile 1 sealing profiles 15 and 16. Here the sealing profile 15 is formed on the side pointing toward the machine tool table 2 as a lip seal. At the other side the lip seal is designed in such a way that it can be placed on the covering strip 14 at the upper edge 14/1. Such a design of the seal 15 ensures a reliable seal both toward the machine tool table 2 and the covering strip 14. The divided design of the lip seal, intended for placement on the upper edge 14/1 of the covering strip 14, ensures that the sealing profile can be fastened with interlocking and/or non-positive fit to the covering strip 14.

The fastening means, by means of which the covering plate 14 is fastened to the machine tool table or the duct profile, is designated by the reference numeral 17. The sealing profile 16 provided on the side of the covering strip 14 pointing toward the duct or duct profile 1 is designed as an angle profile. One side of the seal/angle profile 16/1 is inserted in a recess 14/2 simultaneously holding the seal 16 and providing a seal with respect to the duct interior.

It can also be seen in the diagram of FIG. 2 that the covering strip 14 at the side pointing toward the duct or duct profile 1 is bent toward the duct interior. The covering strip 14 is bent obliquely substantially from the end of the recess 14/2 and then again assumes a perpendicular position in the duct interior. This type of design ensures a reliable splash guard for the seal 16.

The claims submitted now with the application later are attempts at wording without prejudice to the obtaining of continuing protection.

The relationships cited in the dependent claims refer to the further development of the subject of the main claim provided for by the features of the respective sub-claims. However, these relationships must not be interpreted as waiving the requirement to obtain independent, subjective protection for the features of the related sub-claims.

Features which have so far only been disclosed in the description may be claimed in the course of the proceedings as being of significance to the invention, for example, for delimitation from the prior art.

While the invention has been described in connection with what is presently considered to be the most practical and preferred embodiment, it is to be understood that the invention is not to be limited to the disclosed embodiments but, on the contrary, is intended to cover the various modifications and equivalent arrangements included within the spirit and scope of the appended claims, which scope is to be accorded the broadest interpretation so as to encompass all such modifications and equivalent structures as is permitted under the law.

What is claimed:

1. A machine or plant having a machine tool table with at least one duct or duct profile for draining liquid media, in particular coolants or flushing liquids, incorporated in said machine tool table, and a seal being arranged between said machine tool table and said duct profile, said machine tool table having at least one leg reaching into said duct profile, said leg comprising a sealing area cooperating with said seal or carrying said seal and said leg being designed in such a way that it acts as a splash guard for said seal.

2. A machine or plant having a machine tool table with at least one duct or duct profile for draining liquid media, in particular coolants or flushing liquids, which is incorporated in said machine tool table, and a seal being arranged between said machine tool table and said duct profile, wherein a seal or a seal-carrying sealing face or a sealing area is arranged at or on a longitudinally extending end of said duct profile.

3. The machine or plant stated in claim 1, said sealing faces of said machine tool table being arranged in an outwardly pointing U-shaped or nose-like opening of said leg.

4. The machine or plant stated in claim 1, said duct profile having a U-shaped or nose-like upper edge having an open side, on said open side of which a seal, sealing area or seal-carrying sealing face is arranged.

5. The machine or plant stated in claim 1, said duct profile having a U-shaped upper edge open at the top in an installation direction.

6. The machine or plant stated in claim 1, wherein said seal has at least two sides and is designed in such a way that it can be placed with one side on an upper edge of the duct profile, so it encloses and simultaneously seals the open side of the duct profile.

7. The machine or plant as stated in claim 6, wherein the other side of said seal pointing toward said sealing area of said machine tool table forms with said sealing area the seal between machine tool table and duct profile.

8. The machine or plant stated in claim 1, the sealing area being designed in such a way that with the side pointing toward said machine toot table said seal can be placed on or inserted in the sealing area and the side of said seal pointing toward said duct profile forms a seal with a sealing area arranged on the upper edge of said duct profile.

9. The machine or plant stated in claim 1, said seal being formed on the side of said machine tool table pointing toward said sealing area as a rounded profile or as a square profile.

10. The machine or plant stated in claim 1, wherein at the side pointing toward said sealing area of said machine tool table, said seat additionally has at least one sealing nose or sealing lip directed toward said sealing area.

11. The machine or plant stated in claim 1, wherein at the side pointing toward said sealing area of said machine tool table, said seal is designed as a lip seal.

12. The machine or plant stated in claim 1, wherein at the side pointing toward said sealing area of said machine tool table, said seal is designed as a tubular hollow section.

13. The machine or plant stated in claim 1, wherein the sealing faces of said machine tool table are crude, cast or machined.

14. The machine or plant stated in claim 1, wherein said duct profiles are formed of metal, sheet metal, plastics material or composite materials.

15. The machine or plant stated in claim 1, wherein said duct profile has at least one assembly aid by means of which said duct profile can be raised and lowered.

16. The machine or plant stated in claim 15, wherein said assembly aid is arranged beneath said duct profile.

17. The machine or plant stated in claim 15, wherein said assembly aid is formed by at least one eccentric.

18. The machine or plant stated in claim 15, wherein said assembly aid is formed so as to be mountable and detachable.

19. The machine or plant stated in claim 15, wherein said assembly aid comprises rails and/or rollers arranged beneath the duct profile.

20. The machine or plant stated in claim 1, wherein at least one connecting part, in particular as part of the duct profile, is arranged between a connecting side of said machine tool table and extensions of said machine tool table with a leg reaching into said duct profile, said leg comprising a sealing area cooperating with said seal or carrying said seal, and said leg being designed in such a way that it acts as a splash guard for said seal.

21. The machine or plant stated in claim 20, wherein said leg pointing into said duct profile is designed as a moulding bent so as to be U-shaped or nose-like.

22. The machine or plant stated in claim 20, wherein an upper end of said connecting part is adapted to the shape of said machine tool table and can be fastened thereon.

23. The machine or plant stated in claim 20, wherein a sealing plate trapezoidal in cross-section is arranged between a slope of an upper nose of said duct or duct profile and said connecting part.

24. A machine or plant having a machine tool table with at least one duct or duct profile arranged in the installed state below said machine tool table in the ground or in an assembly surface of said machine tool table, wherein at least one covering strip, corresponding to the shape of the cross-section of said machine tool table at a connecting face or the shape of the connection on said duct profile, is arranged between said duct or duct profile and said machine tool table as part of said duct profile.

25. The machine or plant stated in claim 24, wherein said covering strip carries a first sealing profile on the side pointing toward said connecting face of said machine tool table and a second sealing profile on the side pointing toward said duct profile.

26. The machine or plant stated in claim 25, where at the side pointing toward said machine tool table, said first sealing profile is designed as a lip seal.

27. The machine or plant stated in claim 25, wherein at the side pointing toward said covering strip, said first sealing profile is designed in such a way that it can be placed on said covering strip so it encloses and simultaneously seals an upper edge thereof.

28. The machine or plant stated in claim 25, wherein at the side pointing toward said duct or duct profile, said second sealing profile is bent outwards, viewed from said duct profile.

29. The machine or plant stated in claim 28, wherein said second sealing profile is arranged with a side non-positively and/or with interlocking fit in a recess of said covering strip.

30. The machine or plant stated in claim 29, wherein at the side pointing toward said duct or duct profile, said covering strip is bent toward the duct interior in such a way that it extends obliquely from the end of said recess and then vertically again into said duct interior.

31. The machine or plant stated in claim 24, wherein said covering strip is adapted in its dimensions to the gradient of said machine tool table or said duct or duct profile.

32. The machine or plant stated in claim 25, wherein said sealing profiles are formed as microcellular rubber, silicone, unvulcanised rubber, fluoroelastomers (such as Viton), in particular from a material resistant to the medium or media to be sealed.

33. A method for assembling machines or plant having at least one machine tool table, under the/or each machine tool table of which at least one duct profile is incorporated, wherein said duct profile carrying a seal at its open end or comprising a sealing face cooperating with a seal is inserted into said machine tool table in such a way that the sealing area arranged on said duct profile and cooperating with said seal is spaced apart from a sealing area of said machine tool table cooperating with said seal in such a way that a gap remains between said seal and said sealing face and afterward, once said duct profile has achieved its assembly position, there is a relative movement between said duct profile and said machine tool table in order to close said gap.

34. The method stated in claim 33, comprising the following:
said duct profile is inserted at a higher or lower level with respect to said sealing face, depending on the design of the upper edge of the duct profile, such that said sealing profiles still do not come into contact with said sealing areas of said machine tool table;
after achieving the end position with respect to said machine tool table said duct profile is lowered or raised in such a way that said sealing profiles come into contact with said sealing faces of said machine tool table and produce a seal.

35. The method stated in claim 33, further comprising the use of an assembly aid by means of which said duct profile is raised and lowered and during insertion of said duct profile the latter is held in the raised or lowered position until the end position is achieved.

36. The method stated in claim 33, in which:
in a first method step said duct profile is inserted in openings of said machine tool table with a spacing with respect to said sealing area, depending on the design of the sealing face, in such a way that said sealing profile(s) do not come into contact with the sealing faces of said machine tool table or of said duct profile, and
in a further method step said duct profile, after achieving the end position with respect to said machine profile, is moved vertically and/obliquely with its open side in such a way that said seating profile(s) come(s) into contact with said sealing areas of the machine tool table or of said duct profile and produce a seal.

37. A method for assembling machines or plant having at least one machine tool table under the or each machine tool table of which at least one duct profile is incorporated, comprising:
the gap between said duct profile and said machine frame is covered by means of at least one covering strip,
said covering strip(s) is/are fastened by fastening means, provided on said machine frame, arranged thereon and corresponding therewith.
